(19) United States
(12) Patent Application Publication
(10) Pub. No.: US 2026/0326797 A1
(43) Pub. Date: Oct. 22, 2026

(54) Transport Facility

(71) Applicant: Daifuku Co., Ltd., Osaka-shi (JP)

(72) Inventor: Kengo Ikedo, Komaki-shi (JP)

(21) Appl. No.: 19/653,345

(22) Filed: Apr. 21, 2026

(30) Foreign Application Priority Data
Apr. 22, 2025 (JP) 2025-070320

(51) Int. Cl. B61L 23/34; B61L 23/12

(52) U.S. Cl. CPC B61L 23/34; B61L 23/12

(57) ABSTRACT

A transport facility includes a control system that determines whether acceleration conditions including a travel path having an acceleration permitting shape on a front side of a target vehicle and a preceding vehicle detector in the target vehicle not detecting a preceding vehicle in a detection range are satisfied, determines whether the preceding vehicle is in a stopped state or low-speed travel state in response to determining that the conditions are satisfied in the first determination, causes the target vehicle to accelerate in response to determining that the preceding vehicle is neither in the stopped state nor in the low-speed travel state in the second determination, and causes the target vehicle to be in an acceleration prohibited state in response to determining that the conditions are not satisfied in the first determination or the preceding vehicle is in the stopped state or the low-speed travel state in the second determination.

### CROSS-REFERENCE TO RELATED APPLICATION

This application claims priority to Japanese Patent Application No. 2025-070320 filed Apr. 22, 2025, the disclosure of which is hereby incorporated by reference in its entirety.

### BACKGROUND OF THE INVENTION

### Field of the Invention

The present invention relates to a transport facility including multiple transport vehicles that travel along a travel path and transport articles, and a control system that controls the multiple transport vehicles.

### Description of Related Art

An example of such a transport facility is described in Japanese Unexamined Patent Application Publication No. 5-134742 (JP 5-134742). In the background described hereafter, reference signs in parentheses are the reference signs in JP 5-134742.

The transport facility in JP 5-134742 includes multiple transport vehicles (2) each including an inter-vehicle distance detector (10) that detects a distance to a preceding vehicle that is a transport vehicle (2) on a front side in a travel direction. A control system (8) causes each transport vehicle (2) to accelerate, decelerate, or stop based on the distance detected by the corresponding inter-vehicle distance detector (10).

The transport facility described in JP 5-134742 allows the transport vehicle (2) to accelerate when the distance detected by the inter-vehicle distance detector (10) is long. When the preceding vehicle stops, for example, the transport vehicle (2) decelerates as it approaches the preceding vehicle, and then stops finally.

As described above, the transport facility described in JP 5-1347421 may cause the transport vehicles (2) to switch from acceleration to deceleration in a short period. Such unintended acceleration and deceleration of the transport vehicles (2) degrade the energy efficiency.

### SUMMARY OF THE INVENTION

Transport facilities that can reduce energy consumption caused by unintended acceleration and deceleration of transport vehicles are awaited.

In response to the above, a transport facility includes a plurality of transport vehicles that travel along a travel path and transport articles, and a control system that controls the plurality of transport vehicles. Each of the plurality of transport vehicles includes a preceding vehicle detector that detects a preceding vehicle within a detection range defined on a front side of the transport vehicle. The preceding vehicle is, among the plurality of transport vehicles, a vehicle on the front side in a travel direction of a target vehicle. The target vehicle is a vehicle to be controlled by the control system among the plurality of transport vehicles. The control system performs a first process, a second process, a third process, and a fourth process. The first process is a process for determining whether acceleration conditions are satisfied. The acceleration conditions include the travel path having a preset acceleration permitting shape on the front side of the target vehicle and the preceding vehicle detector in the target vehicle not detecting the preceding vehicle in the detection range. The second process is a process for determining whether the preceding vehicle on the front side of the detection range is in a stopped state or a low-speed travel state in which the preceding vehicle travels at a travel speed lower than or equal to a preset speed. The third process is a process for causing the target vehicle to accelerate in response to the control system determining that the acceleration conditions are satisfied in the first process and determining that the preceding vehicle is neither in the stopped state nor in the low-speed travel state in the second process. The fourth process is a process for causing the target vehicle to be in an acceleration prohibited state in which the target vehicle is prohibited from accelerating in response to the control system determining that the acceleration conditions are not satisfied in the first process or determining that the preceding vehicle is in the stopped state or the low-speed travel state in the second process.

In this structure, the target vehicle satisfying the acceleration conditions is in the acceleration prohibited state when the preceding vehicle is in the stopped state or the low-speed travel state. This prevents the target vehicle satisfying the acceleration conditions from accelerating when the target vehicle is likely to decelerate in response to the preceding vehicle being in the stopped state or the low-speed travel state. This reduces energy consumption caused by unintended acceleration and deceleration of the transport vehicles.

### BRIEF DESCRIPTION OF THE DRAWINGS

FIG. 1 is a diagram of a transport facility according to an embodiment.

FIG. 2 is a block diagram of the transport facility according to the embodiment.

FIG. 3 is a diagram of an example control process performed by a control system.

FIG. 4 is a flowchart of the example control process performed by the control system.

FIG. 5 is a diagram of an example control process performed by a control system.

### DESCRIPTION OF THE INVENTION

A transport facility 100 according to an embodiment will be described below with reference to the drawings.

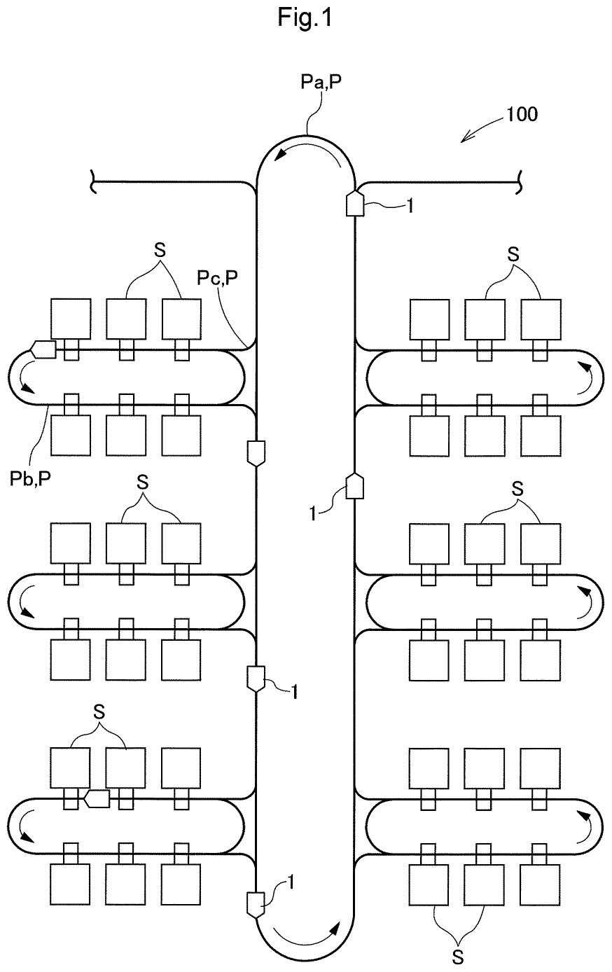

As shown in FIG. 1, the transport facility 100 includes multiple transport vehicles 1 that travel along a travel path P and transport articles.

In the present embodiment, the travel path P is defined by a rail hung from the ceiling. In other words, the transport vehicles 1 in the present embodiment are ceiling-hung transport vehicles. The transport vehicles 1 transport articles that are, for example, front-opening unified pods (FOUPs) containing semiconductor substrates.

In the present embodiment, the travel path P includes a looped main path Pa, multiple looped subpaths Pb each extending through multiple stations S, and multiple connection paths Pc that connect the main path Pa and the multiple subpaths Pb.

Each station S allows a transport vehicle 1 that stops at a position corresponding to the station S to, for example, transfer an article to and from the station S. Each station S is, for example, a load port of a processing device that processes the article, a loading and unloading port of a storage device for storing the article, or a storage shelf for temporarily storing the article.

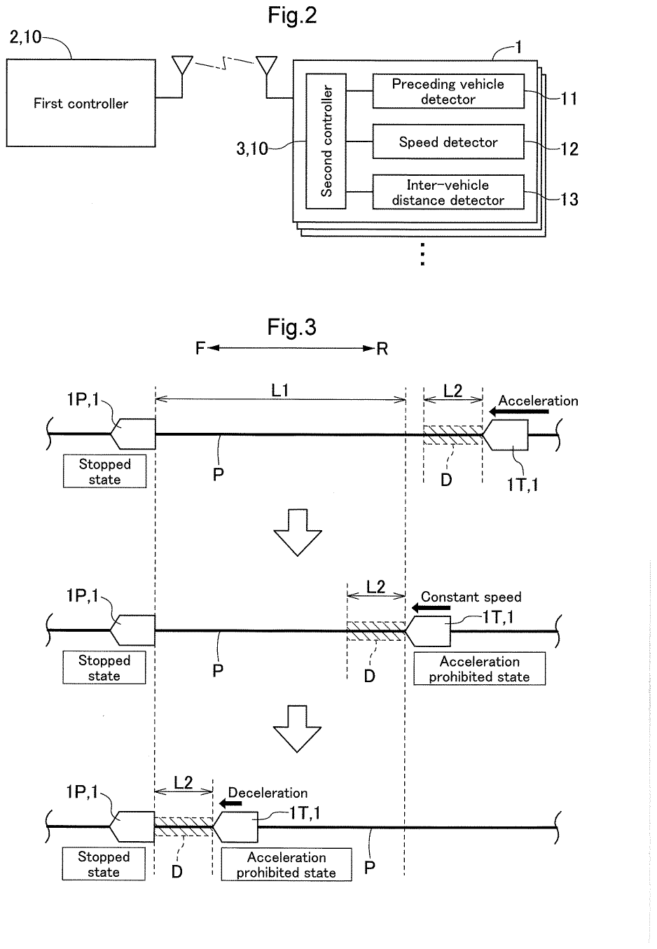

As shown in FIG. 2, the transport facility 100 includes a control system 10 that controls the multiple transport vehicles 1. In the present embodiment, the control system 10 includes a first controller 2 disposed at a predetermined location in the transport facility 100, and second controllers 3 included in each of the multiple transport vehicles 1. The first controller 2 can wirelessly communicate with the multiple second controllers 3.

The first controller 2 transmits control commands to the multiple second controllers 3. Each second controller 3 controls the transport vehicle 1 including the second controller 3 based on the control commands from the first controller 2.

In the present embodiment, the control system 10 obtains positional information of each transport vehicle 1. In this structure, the first controller 2 communicates with the transport vehicles 1 to obtain the positional information of each transport vehicle 1, and each second controller 3 identifies the positional information of the transport vehicle 1 including the second controller 3.

The front side in the travel direction of the transport vehicle 1 is hereafter referred to as a front side F, and the rear side in the travel direction of the transport vehicle 1 is hereafter referred to as a rear side R (refer to FIG. 3). The transport vehicle 1 that is a target to be controlled by the control system 10 is referred to as a target vehicle 1T. The transport vehicle 1 on the front side F of the target vehicle 1T is referred to as a preceding vehicle 1P. In the present embodiment, the preceding vehicle 1P is the transport vehicle 1 on the front side F of the target vehicle 1T and at the rearmost position toward the rear side R. Two or more transport vehicles 1 on the front side F of the target vehicle 1T may be referred to as preceding vehicles 1P.

As shown in FIG. 2, each transport vehicle 1 includes a preceding vehicle detector 11. In the present embodiment, each transport vehicle 1 further includes a speed detector 12 and an inter-vehicle distance detector 13.

The preceding vehicle detector 11 detects the preceding vehicle 1P in a detection range D defined on the front side F of the target vehicle 1T including the preceding vehicle detector 11. The preceding vehicle detector 11 may be, for example, a collision avoidance sensor, a laser rangefinder, or a camera.

The speed detector 12 detects the travel speed of the transport vehicle 1 including the speed detector 12.

The inter-vehicle distance detector 13 detects the distance (inter-vehicle distance) between the target vehicle 1T including the inter-vehicle distance detector 13 and the preceding vehicle 1P. The inter-vehicle distance detector 13 may be, for example, a laser rangefinder or a camera. A single device may function as both the preceding vehicle detector 11 and the inter-vehicle distance detector 13.

FIG. 3 is a diagram of an example control process performed by the control system 10. In the example shown in FIG. 3, the control system 10 causes the target vehicle 1T to accelerate when the distance (inter-vehicle distance) between the target vehicle 1T and the preceding vehicle 1P detected by the inter-vehicle distance detector 13 is greater than a preset first distance L1 and acceleration conditions are satisfied (refer to the upper part of FIG. 3).

The acceleration conditions include that the travel path P having a preset acceleration permitting shape on the front side F of the target vehicle 1T (hereafter referred to as a first condition), and the preceding vehicle detector 11 in the target vehicle 1T detecting no preceding vehicle 1P within the detection range D (hereafter referred to as a second condition). In the present embodiment, the acceleration conditions further include that a stop position of the target vehicle 1T (e.g., a station S) being not at a preset distance (e.g., a deceleration distance based on the travel speed of the target vehicle 1T) toward the front side F from the current position of the target vehicle 1T (hereafter referred to as a third condition).

The acceleration conditions being satisfied herein refers to all the acceleration conditions (in this example, the first, second, and third conditions) being satisfied.

In the present embodiment, the acceleration permitting shape is a straight line. More specifically, the acceleration permitting shape is a straight line without any curve, branch, or junction in a portion of the travel path P from the current position of the target vehicle 1T to a position at a preset distance toward the front side F.

In the example shown in FIG. 3, the control system 10 causes the target vehicle 1T satisfying the acceleration conditions to be in the acceleration prohibited state in which the target vehicle 1T is restricted from accelerating when the distance (inter-vehicle distance) between the target vehicle 1T and the preceding vehicle 1P is less than or equal to the first distance L1 and the preceding vehicle 1P on the front side F of the detection range D is in the stopped state (refer to the middle part of FIG. 3). In addition to when the preceding vehicle 1P is in the stopped state, the control system 10 also causes the target vehicle 1T to be in the acceleration prohibited state when the preceding vehicle 1P on the front side F of the detection range D travels at a travel speed less than or equal to a preset speed (e.g., 10 m/min). The preset speed may be 0 m/min. In this case, the control system 10 causes the target vehicle 1T to be in the acceleration prohibited state only when the preceding vehicle 1P is in the stopped state.

In this example, when causing the target vehicle 1T to be in the acceleration prohibited state as described above, the control system 10 causes the target vehicle 1T to maintain the current travel speed, or in other words, causes the target vehicle 1T to travel at a constant speed.

The control system 10 may calculate the travel speed of the preceding vehicle 1P based on an amount of change in the positional information of the preceding vehicle 1P over time to determine whether the preceding vehicle 1P is in the stopped state or the low-speed travel state based on the calculated travel speed. The control system 10 may also calculate a relative speed of the target vehicle 1T with respect to the preceding vehicle 1P based on an amount of change in the distance detected by the inter-vehicle distance detector 13 in the target vehicle 1T over time. The control system 10 then determines whether the preceding vehicle 1P is in the stopped state or the low-speed travel state based on a difference between the calculated relative speed and a travel speed detected by the speed detector 12 in the target vehicle 1T. The control system 10 may also determine whether the preceding vehicle 1P is in the stopped state or the low-speed travel state based on the travel speed of the preceding vehicle 1P detected by the speed detector 12 in the preceding vehicle 1P.

When the preceding vehicle detector 11 in the target vehicle 1T, which is in the acceleration prohibited state and traveling at a constant speed, detects a preceding vehicle 1P, the control system 10 causes the target vehicle 1T to decelerate (refer to the lower part of FIG. 3) and to stop on the rear side R of the preceding vehicle 1P as shown in the example in FIG. 3. In this example, the detection range D of the preceding vehicle detector 11 is defined as the range from the current position of the target vehicle 1T to a position at the preset second distance L2 toward the front side F. The second distance L2 is less than the first distance L1.

The control system 10 causes the target vehicle 1T in the acceleration prohibited state to maintain the current travel speed until the preceding vehicle detector 11 in the target vehicle 1T detects a preceding vehicle 1P.

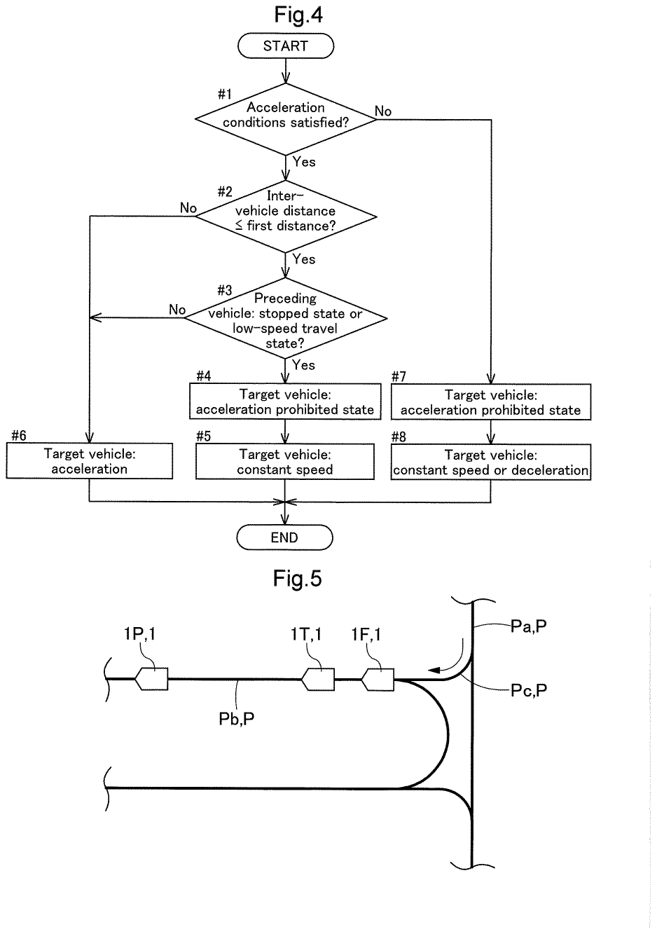

FIG. 4 is a flowchart of an example control process performed by the control system 10. As shown in FIG. 4, the control system 10 first determines whether the acceleration conditions described above are satisfied (step #1).

When determining that the acceleration conditions are satisfied (Yes in step #1), the control system 10 determines whether the distance (inter-vehicle distance) between the target vehicle 1T and the preceding vehicle 1P detected by the inter-vehicle distance detector 13 is less than or equal to the first distance L1 described above (step #2).

When determining that the inter-vehicle distance is less than or equal to the first distance L1 (Yes in step #2), the control system 10 determines whether the preceding vehicle 1P on the front side F of the detection range D is in the stopped state or the low-speed travel state (step #3).

When determining that the preceding vehicle 1P is in the stopped state or the low-speed travel state (Yes in step #3), the control system 10 causes the target vehicle 1T to be in the acceleration prohibited state (step #4). The control system 10 then causes the target vehicle 1T to maintain the current travel speed, or in other words, causes the target vehicle 1T to travel at a constant speed (step #5).

When determining that the inter-vehicle distance is greater than the first distance L1 in step #2 (No in step #2) or determining that the preceding vehicle 1P is neither in the stopped state nor in the low-speed travel state in step #3 (No in step #3), the control system 10 causes the target vehicle 1T to accelerate (step #6).

When determining that the acceleration conditions are not satisfied in step #1 (No in step #1), the control system 10 causes the target vehicle 1T to be in the acceleration prohibited state (step #7). The control system 10 then causes the target vehicle 1T to maintain the current travel speed, or in other words, causes the target vehicle 1T to travel at a constant speed or to decelerate (step #8).

In this example, step #1 corresponds to a first process, step #3 corresponds to a second process, step #6 corresponds to a third process, steps #4 and #7 correspond to a fourth process, and step #5 corresponds to a fifth process.

### Other Embodiments

(1) In the above embodiment, the control system 10 causes the target vehicle 1T in the acceleration prohibited state to maintain the current travel speed until the preceding vehicle detector 11 in the target vehicle 1T detects a preceding vehicle 1P. However, the structure is not limited to this example. The control system 10 may control the transport vehicles 1 as described below.

For example, when a target vehicle 1T in the acceleration prohibited state is traveling at a constant speed and the preceding vehicle detector 11 in a following vehicle 1F, which is a transport vehicle 1 on the rear side R of the target vehicle 1T, detects the target vehicle 1T, the control system 10 causes the target vehicle 1T to accelerate until the target vehicle 1T reaches a predetermined position (e.g., a position at slightly greater than the second distance L2 toward the rear side R from the current position of the preceding vehicle 1P), as shown in FIG. 5. The control system 10 then causes the following vehicle 1F to accelerate or travel at a constant speed without deceleration. Such control may be performed when the target vehicle 1T is in an area that is likely to be congested with the transport vehicles 1 such as an area around a junction of travel paths P (a joint between a connection path Pc and a subpath Pb) shown in FIG. 5. Such control reduces congestion of the transport vehicles 1, improving the transport efficiency of the transport vehicles 1 that transport articles. More specifically, when congestion on a route from the main path Pa to the subpath Pb passing through the connection path Pc causes a transport vehicle 1 located at the rear end of congestion to remain on the main path Pa, a following transport vehicle 1 not traveling toward the subpath Pb cannot travel further along the main path Pa. However, the control described above prevents the transport vehicle 1 continuing to travel along the main path Pa without traveling toward the subpath Pb from being affected by the above congestion.

(2) In the above embodiment, each transport vehicle 1 is a ceiling-hung transport vehicle that travels along the travel path P defined by rails hung from the ceiling. In some embodiments, the transport vehicle 1 may be, for example, a tracked transport vehicle that travels along a travel path P defined by rails on the floor surface. The transport vehicle 1 may be a trackless transport vehicle that travels along a travel path P defined virtually. In this case, the travel path P can be defined by multiple detectable members (e.g., two-dimensional codes, radio frequency tags or RF tags, or magnetic tape).

(3) In the above embodiment, the control system 10 includes the first controller 2 and the second controllers 3 each included in the corresponding one of the multiple transport vehicles 1. The first controller 2 provides instructions to the multiple second controllers 3. In some embodiments, for example, the multiple second controllers 3 may operate independently of or in cooperation with one another.

(4) The structure described in each of the above embodiments may be combined with any other structures described in the other embodiments unless any contradiction arises. The embodiments described herein are mere examples in all respects. Thus, the embodiments described herein may be modified variously as appropriate without departing from the spirit and scope of the disclosure.

### Overview of Present Embodiment

An overview of the transport facility described above is provided below.

A transport facility includes a plurality of transport vehicles that travel along a travel path and transport articles, and a control system that controls the plurality of transport vehicles. Each of the plurality of transport vehicles includes a preceding vehicle detector that detects a preceding vehicle within a detection range defined on a front side of the transport vehicle. The preceding vehicle is, among the plurality of transport vehicles, a vehicle on the front side in a travel direction of a target vehicle. The target vehicle is a vehicle to be controlled by the control system among the plurality of transport vehicles. The control system performs a first process, a second process, a third process, and a fourth process. The first process is a process for determining whether acceleration conditions are satisfied. The acceleration conditions include the travel path having a preset acceleration permitting shape on the front side of the target vehicle and the preceding vehicle detector in the target vehicle not detecting the preceding vehicle in the detection range. The second process is a process for determining whether the preceding vehicle on the front side of the detection range is in a stopped state or a low-speed travel state in which the preceding vehicle travels at a travel speed lower than or equal to a preset speed. The third process is a process for causing the target vehicle to accelerate in response to the control system determining that the acceleration conditions are satisfied in the first process and determining that the preceding vehicle is neither in the stopped state nor in the low-speed travel state in the second process. The fourth process is a process for causing the target vehicle to be in an acceleration prohibited state in which the target vehicle is prohibited from accelerating in response to the control system determining that the acceleration conditions are not satisfied in the first process or determining that the preceding vehicle is in the stopped state or the low-speed travel state in the second process.

In this structure, the target vehicle satisfying the acceleration conditions is in the acceleration prohibited state when the preceding vehicle is in the stopped state or the low-speed travel state. This prevents the target vehicle satisfying the acceleration conditions from accelerating when the target vehicle is likely to decelerate in response to the preceding vehicle being in the stopped state or the low-speed travel state. This reduces energy consumption caused by unintended acceleration and deceleration of the transport vehicles.

In response to the control system causing the target vehicle to be in the acceleration prohibited state in the fourth process based on determination that the preceding vehicle is in the stopped state or the low-speed travel state in the second process, the control system may perform a fifth process for causing the target vehicle to maintain a current travel speed of the target vehicle until the preceding vehicle detector in the target vehicle detects the preceding vehicle.

In this structure, the target vehicle in the acceleration prohibited state travels at a constant speed without acceleration or deceleration until the preceding vehicle detector in the target vehicle detects the preceding vehicle. This appropriately reduces energy consumption caused by unintended acceleration and deceleration of the transport vehicles.

The control system may obtain positional information of each of the plurality of transport vehicles. The control system may calculate, in the second process, a travel speed of the preceding vehicle based on an amount of change in the positional information of the preceding vehicle over time to determine whether the preceding vehicle is in the stopped state or the low-speed travel state based on the calculated travel speed.

This structure allows appropriate determination as to whether the preceding vehicle is in the stopped state or the low-speed travel state.

Each of the plurality of transport vehicles may further include a speed detector that detects a travel speed of the transport vehicle and an inter-vehicle distance detector that detects a distance to the preceding vehicle. The control system may calculate, in the second process, a relative speed of the target vehicle with respect to the preceding vehicle based on an amount of change in the distance detected by the inter-vehicle distance detector in the target vehicle over time to determine whether the preceding vehicle is in the stopped state or the low-speed travel state based on a difference between the calculated relative speed and the travel speed detected by the speed detector in the target vehicle.

This structure allows appropriate determination as to whether the preceding vehicle is in the stopped state or the low-speed travel state.

### INDUSTRIAL APPLICABILITY

The technique according to one or more embodiments of the disclosure can be used for a transport facility including multiple transport vehicles that travel along a travel path and transport articles, and a control system that controls the multiple transport vehicles.

What is claimed is:

1. A transport facility, comprising:
a plurality of transport vehicles configured to travel along a travel path and transport articles; and
a control system configured to control the plurality of transport vehicles,
wherein:
each of the plurality of transport vehicles comprises a preceding vehicle detector configured to detect a preceding vehicle within a detection range defined on a front side of the transport vehicle, the preceding vehicle comprising, among the plurality of transport vehicles, a vehicle on the front side in a travel direction of a target vehicle, the target vehicle comprising a vehicle to be controlled by the control system among the plurality of transport vehicles, and
the control system is configured to perform:
a first process for determining whether acceleration conditions are satisfied, the acceleration conditions comprising the travel path having a preset acceleration permitting shape on the front side of the target vehicle and the preceding vehicle detector in the target vehicle not detecting the preceding vehicle in the detection range,
a second process for determining whether the preceding vehicle on the front side of the detection range is in a stopped state or a low-speed travel state in which the preceding vehicle travels at a travel speed lower than or equal to a preset speed,
a third process for causing the target vehicle to accelerate in response to the control system determining that the acceleration conditions are satisfied in the first process and determining that the preceding vehicle is neither in the stopped state nor in the low-speed travel state in the second process, and
a fourth process for causing the target vehicle to be in an acceleration prohibited state in which the target vehicle is prohibited from accelerating in response to the control system determining that the acceleration conditions are not satisfied in the first process or determining that the preceding vehicle is in the stopped state or the low-speed travel state in the second process.

2. The transport facility according to claim 1, wherein:
in response to the control system causing the target vehicle to be in the acceleration prohibited state in the fourth process based on determination that the preceding vehicle is in the stopped state or the low-speed travel state in the second process, the control system performs a fifth process for causing the target vehicle to maintain a current travel speed of the target vehicle until the preceding vehicle detector in the target vehicle detects the preceding vehicle.

3. The transport facility according to claim 1, wherein:
the control system obtains positional information of each of the plurality of transport vehicles, and
the control system calculates, in the second process, a travel speed of the preceding vehicle based on an amount of change in the positional information of the preceding vehicle over time to determine whether the preceding vehicle is in the stopped state or the low-speed travel state based on the calculated travel speed.

4. The transport facility according to claim 1, wherein:
each of the plurality of transport vehicles further comprises a speed detector configured to detect a travel speed of the transport vehicle and an inter-vehicle distance detector configured to detect a distance to the preceding vehicle, and
the control system calculates, in the second process, a relative speed of the target vehicle with respect to the preceding vehicle based on an amount of change in the distance detected by the inter-vehicle distance detector in the target vehicle over time to determine whether the preceding vehicle is in the stopped state or the low-speed travel state based on a difference between the calculated relative speed and the travel speed detected by the speed detector in the target vehicle.
